(19) United States
(12) Patent Application Publication
(10) Pub. No.: US 2014/0304290 A1
(43) Pub. Date: Oct. 9, 2014

(54) SCREENING TOOL FOR PROVIDERS OF SYNTHETIC DOUBLE STRANDED DNA

(71) Applicant: UT-BATELLE, LLC, Oak Ridge, TN (US)

(72) Inventors: Thomas S. Brettin, Knoxville, TN (US); Robert W. Cottingham, Oak Ridge, TN (US); Daniel J. Quest, Oak Ridge, TN (US)

(73) Assignee: UT-BATELLE, LLC, Oak Ridge, TN (US)

(21) Appl. No.: 14/355,767

(22) PCT Filed: Nov. 2, 2012
(86) PCT No.: PCT/US2012/063309

§ 371 Date: May 1, 2014

Related U.S. Application Data
(60) Provisional application No. 61/555,795, filed on Nov. 4, 2011.

(51) Int. Cl. G06F 19/28; G06F 17/30

(52) U.S. Cl. CPC G06F 19/28; G06F 17/30943
USPC 707/758

(57) ABSTRACT

A screening tool and methodology may examine gene sequences to detect and alert whether there is an indication as to the use of the ordered or purchased gene sequence, or parts thereof, for harmful purposes.

### CROSS-REFERENCE TO RELATED APPLICATION

The present invention claims the benefit of U.S. provisional patent application 61/555,795 filed Nov. 4, 2011, the entire contents and disclosure of which are incorporated herein by reference.

### STATEMENT REGARDING FEDERALLY SPONSORED RESEARCH OR DEVELOPMENT

This invention was made with government support under Prime Contract No. DE-AC05-00OR22725 awarded by the U.S. Department of Energy. The government has certain rights in the invention.

### FIELD

The present disclosure relates generally to DNA synthesis, computers and computer applications and screening DNAs, and more particularly to a screening tool for providers of synthetic double stranded DNA.

### BACKGROUND

DNA synthesis technology is in a period of rapid advancement with significant cost reductions. The inventors in the present application have recognized that as the synthesis technology advances and becomes more accessible, monitoring who is requesting what sequences will only become more significant, which for instance, can be employed to prevent ill-use or harmful use of the technology.

GenoTHREAT from Virginia Tech, The Virginia bioinformatics Institute and ENSIMAG is a sequence screening software tool used to screen and detect potentially threatening sequences. This tool was publicized at the 2010 International Genetically Engineered Machine competition (iGEM) (“About.” iGEM web site. http://ung.igem.org/About (accessed Jan. 18, 2011)).

BlackWatch from Craic Computing is a software program used to screen sequences submitted to DNA synthesis companies. BlackWatch uses a standard suite of algorithms to compare incoming synthesis orders against a database of DNA sequences of known pathogens: viruses and bacteria that cause infectious disease (http://craic.com/). Safeguard also from Craic Computing spots DNA sequences related to pathogenicity, such as genes coding for virulence factors or toxins. BLAST: Basic Local Alignment Search Tool from National Center for Biotechnology Information (NCBI) is able to find regions of local similarity between DNA sequences. The program can compare nucleotide or protein sequences to sequence databases and calculate the statistical significance of matches. (http://blast.ncbi.nlm.nih.gov/Blast.cgi).

### BRIEF SUMMARY

A method of screening for providers of synthetic double stranded DNA, in one aspect, may include examining gene sequences for a genetic construct; generating an event containing system context at a point when the event was generated if the genetic construct is found; merging the system context with information from a scenario that describes the genetic construct; generating an advisory containing the merged information; and publishing the advisory.

A system for screening for providers of synthetic double stranded DNA, in one aspect, may include a plurality of detectors operable to produce data stream associated with a gene sequence being purchased or obtained by an entity; a plurality of sensors operable to identify in the data stream matching genetic construct from a pre-identify catalog, the plurality of sensors further operable to generate an event in response to finding a match; and a plurality of controllers operable to publish a message based on the generated event, the message including information associated with the data stream having the matching genetic construct.

A computer readable storage medium storing a program of instructions executable by a machine and/or one or more computer processors to perform one or more methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method of screening of the present disclosure in one embodiment.

FIG. 2 is a system diagram illustrating processing element or units in one embodiment of the present disclosure.

FIG. 3 is a flow diagram illustrating a method of detecting a genetic construct in one embodiment of the present disclosure.

FIG. 4 is a diagram showing runtime architecture of the present disclosure in one embodiment.

### DETAILED DESCRIPTION

A methodology is presented in one embodiment that screens or filters purchase orders submitted to DNA synthesis entities. The methodology of the present disclosure in one aspect incorporates DNA screening in conjunction with customer/requester screening. The methodology may be embodied as a software tool and/or as a machine executable form on computer processors that may perform the methodology automatically. The methodology in one embodiment may screen the orders to find or detect one or more indicators that the ordered DNA or such genetic constructs might be used in the construction of a harmful biological agent or the like harmful purposes. In one embodiment of the present disclosure, the methodology may consider information about the genetic constructs (e.g., DNA sequence) being ordered and the individual and/or organization that is purchasing the genetic constructs. In one embodiment of the present disclosure, the methodology may utilize publicly available information sources and may rely on in-depth understanding of genomics and biological function derived therefrom.

A system implementing the methodology of the present disclosure may be also provided. The system in one embodiment may include data elements and processing elements. The data elements describe components of the system and the expected inputs and outputs to data processing units. Data processing elements also send data through messages to other processing units in the system. Each data processing component may be executed on computers that are separated physically. Data in the system may be in the form of, but not limited to, (1) catalogs that are a collection of sequences, (2) extended markup language (XML) documents that describe the implementation of data processing components, and (3) the data that is monitored as it streams through the system.

DNA sequence data that is generated by the latest generation of DNA sequencing instruments is downloaded from the National Center for Biotechnology Information (NCBI), National Institutes of Health and other similar sources of public data. The DNA sequence data represents data that the world-wide research community is contributing to NCBI for redistribution to the public. These DNA sequences, called reads, represent the raw data that is produced by DNA sequencing instruments. The reads sequences come in normal text format or in a standard compressed format. The system and/or methodology of the present disclosure in one embodiment may automatically download new read sets sequences from NCBI on a nightly basis, uncompresses the read sequence set, and then stream the reads to other processing components for further analysis based on properties of the sequences, compile those sequences into catalogs. Alternatively, the system may construct catalogs from curated sequence datasets at public or private institutions. This may include assembled sequences, historical sequences, or unpublished sequences.

The DNA sequences being ordered are extracted from the order, uncompressed if necessary, encapsulated in a message, and placed into a queue for subsequent processing. The queue is a standard distribution point for DNA sequences to multiple computer processing elements. These queues are utilized as part of the documented Publish and Subscribe software architectural pattern. The Publish Subscribe architectural pattern standardizes the connection between all processing components in the system. When a processing component receives a message, it processes the message, updates its status, and then sends a message (publishes) to all subscribers.

DNA sequences being ordered are consumed from the queue. These sequences are examined by automatic computer processing for the presence of genetic constructs that would indicate possible use for harmful or otherwise illegal purposes, or other purposes being looked into or of interest. For instance, NDM-1 is a recently discovered antibiotic resistance gene that confers resistance to beta-lactams. The presence of NDM-1 may indicate possible use for building a biological weapon or the like. Thus, the methodology of the present disclosure may examine the DNA sequence for detecting such genetic constructs.

In one aspect of the present disclosure, a state machine may be implemented which change states based on input to the state machine. For example, on examining the DNA sequences, a state machine will change state if a genetic construct that might flag or alert a possible harmful use (e.g., NDM-1 gene) is found. As a result of the state change to the state machine, an event may be generated and signaled. The event may contain the system context at the point when the event was generated, e.g., with respect to which gene sequence and at what point the event was generated. This system context is merged with information from the scenario that describes the detected genetic construct (e.g., NDM-1 gene) and methods for detecting the gene to generate advisory. This advisory may be published using Internet technology for consumption by interested individuals.

Consider as an illustrative example of a small terrorist cell intent on constructing a biological weapon. One goal such a group may have is to avoid being detected while acquiring the parts needed to create a viable biological weapon. Using a computer and publicly available software, the terrorist may chop up a virus DNA sequence into shorter sequences, append to the ends of the sequence a DNA restriction site, and then embed these small modified virus DNA sequences in much larger DNA sequences. The larger DNA sequence will look mostly like DNA from an organism commonly used in legitimate research applications. Each company will screen the order. The sequences in the order will match most closely the commonly used research organism rather than something in the catalog of known biological weapons. The sequences are synthesized into DNA and shipped. Upon receipt, the smaller virus DNA is retrieved using restriction enzymes matched to the restriction sites and assembled into a complete virus DNA molecule using ligation enzymes. Under this scenario, governments and law enforcement would not detect or know that the terrorist had in his possession a serious biological weapon.

In this illustrative example scenario, the description of the genetic construct includes the virus sequence, the commonly used research organism and the restriction sites. Additional information includes the purchaser, the shipping address, the DNA synthesis companies, and the date and time the orders were placed.

In this illustrative example, the methods for detecting the genetic constructs may involve performing an in silico restriction of the DNA sequence based on a catalog of restriction enzymes, streaming the restriction results to sensors that examine each restriction fragment for matches to catalogs containing DNA sequences of known potential biological weapons. Furthermore, algorithms that look for correlations between different DNA synthesis orders may be applied. Correlations for purchaser, time and shipping address may be computed. Information about the purchaser, date of the order, the shipping address, the restriction sites that flank the virus DNA sequence, and the identity of the virus DNA sequence may be all merged and transmitted as part of an advisory as a system context.

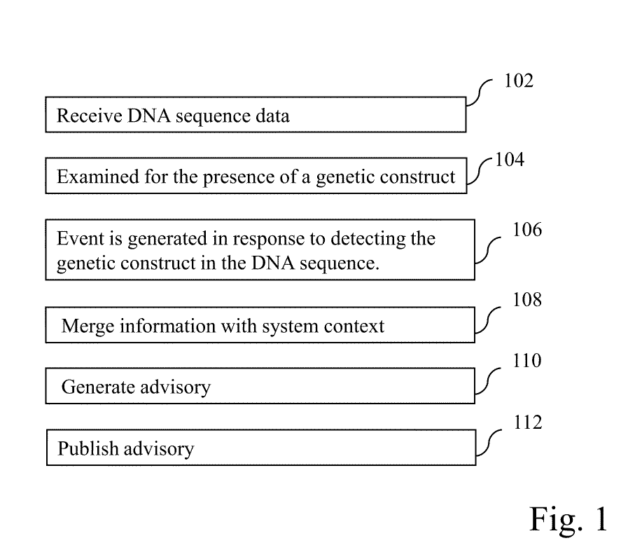

FIG. 1 is a flow diagram illustrating a method of screening of the present disclosure in one embodiment. At 102, DNA sequence data is received. At 104, the received data is examined for the presence of a genetic construct. An example of such genetic construct may include, but is not limited to, antibiotic resistance genes such as NDM-1.

At 106, an event is generated in response to detecting the genetic construct in the DNA sequence. The event includes, for example, information about the purchaser, date of the order, the shipping address, information about the DNA sequence, e.g., the restriction sites that flank the virus DNA sequence. At 108, information associated with the detected genetic construct is merged into the system context. At 110, an advisory is generated containing the merged information.

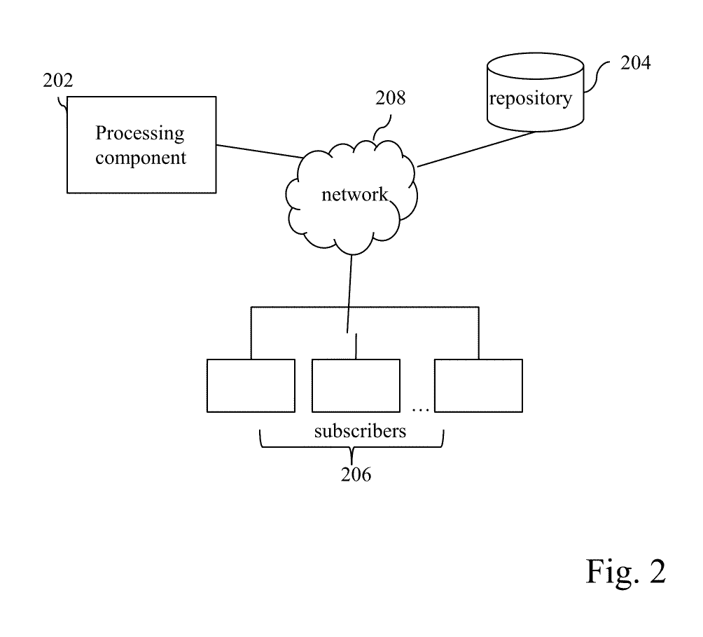

FIG. 2 is a system diagram illustrating processing element or units in one embodiment of the present disclosure. DNA sequence data may be downloaded periodically or dynamically from a repository 204 containing such data, e.g., from NIH. A processing component 202 may process or examine the data to detect the presence of a genetic construct. In response to finding the genetic construct, the processing component 202 may create an event. The event may also include information regarding the detected genetic construct. An advisory may be generated based on the event and published. The publication may be sent to one or more subscribers 206 or requestors that requested the examination of the DNA sequence data. In one aspect, the communication among the processing component 202, the repository 204 and the subscribers 206 may occur remotely via a network 208 such as the Internet.

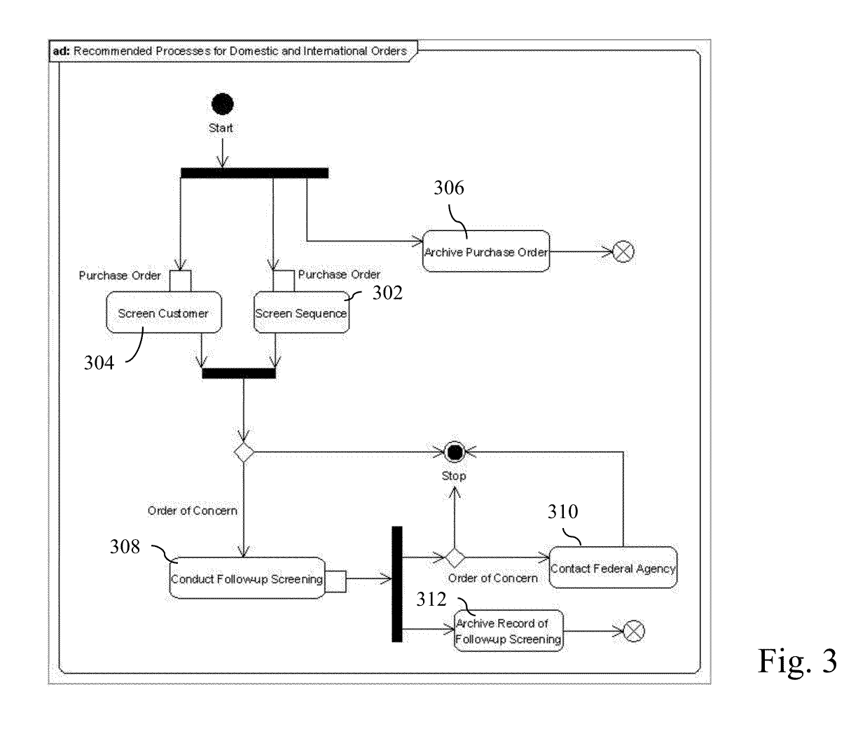

FIG. 3 is a flow diagram illustrating a method of detecting a genetic construct in one embodiment of the present disclosure. At 302, purchase order information for DNA sequence may be screened. At 304, the information about the entity that ordered the DNA sequence is screened. At 306, the purchase order including the information about the customer and the sequence is archived. Based on the screening performed at 302 and 304, it is determined whether there is a concern associated with the order. At 308, in response to determining that there is a concern a follow-up screening may be conducted. The follow-up screening may include more detailed examination of the purchased DNA sequence and/or the customer who purchased or ordered it. In response to determining that the follow-up screening results in confirming the concern, at 310, an appropriate authority may be notified or alerted. At 312, the record of the follow-up screening may be archived.

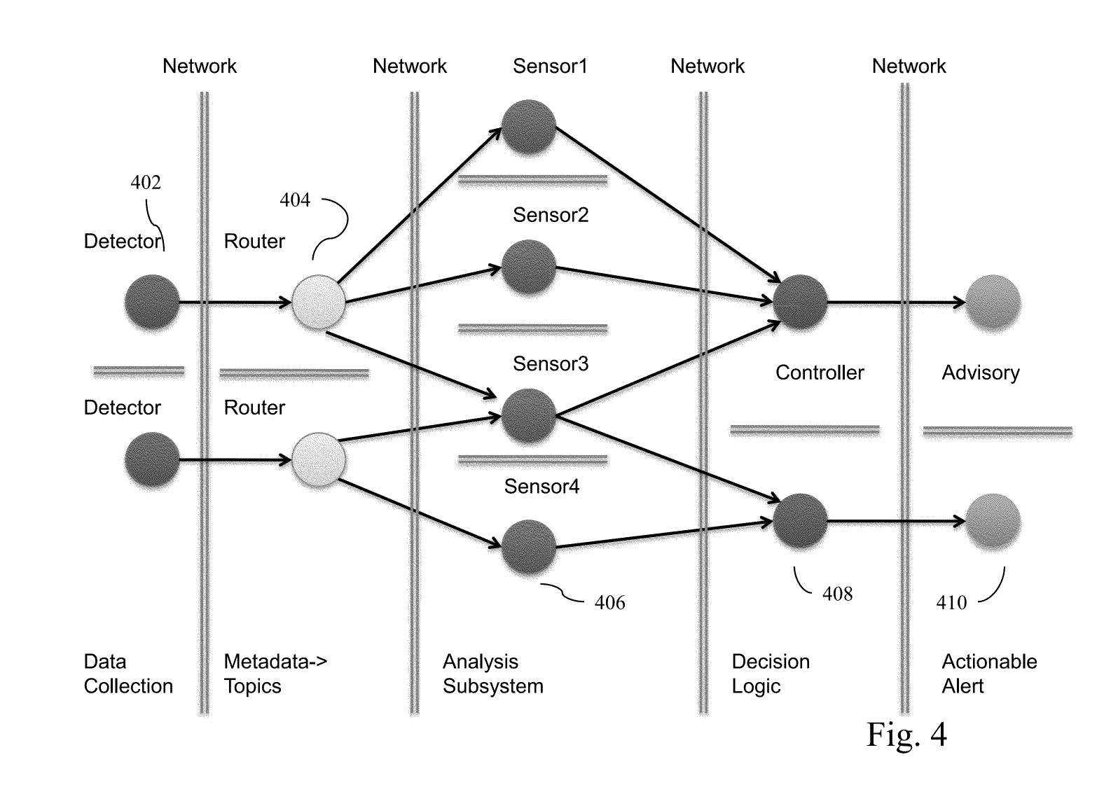

FIG. 4 is a diagram showing runtime architecture of the present disclosure in one embodiment. In this diagram there exists more than one detector, router, sensor controller and advisory. Each system component can exist in different network space. This allows the system to scale in a very similar way to the way the Internet scales. Each system component may scale as the web scales, for example, outside of a single institution, outside of a single funding agency and to the national/ international level. One or more of the components shown in FIG. 4 may be automatic computer processing modules, components or devices.

A scenario (or use case) may start as a text based description of the scientific concepts to be considered, .e.g., that are important. It may be owned and initiated by the expert. Scenarios are refined into software by analyzing the molecular components and other data types present in the source document (some examples include drugs related to the molecular components, assays used by public health professionals, pathways involved, and global position). Such scenario document may be then refined to identify the data used to determine matches in purchase or orders of DNA sequence. The scenario document in one embodiment may include reference catalogs, processing units and/or decision logic used to produce matches. A reference catalog refers to a data set that is used during the screening process. An example may include a set of publically available botulinum toxin sequences obtained from the National Center for Biotechnology. Another example may be a list of people on the following lists: Department of Treasury Office of Foreign Assets Control (OFAC) list of Specially Designated Nationals and Blocked Persons (SDN List); Department of State list of persons engaged in proliferation activities; Department of Commerce Denied Persons List (DPL).

In addition, purchase order information may be used as input to the system or methodology of the present disclosure in one embodiment. The information in the purchase order, for instance, may be processed into data streams. Examples may include a purchase order that contains the sequence data for the gene sequence being purchased, a shipping address, a purchaser name, and other information required to execute a business transaction. A match may occur if there is a correlation between the data received from the scenario and the data in the purchase order.

Detectors 402 in one embodiment of the present disclosure may perform data collection functionalities and also may be referred to as data generators in one embodiment of the present disclosure. For example, detectors produce the data stream that is to be analyzed. Data identified in the scenario and the purchase order is structured as a data stream (also referred to as streaming data), and published as a batch of messages to one or more routers 404 along with the context. The detector context describes the detector and the conditions under which it is operating. In one embodiment, a detector is a software component that sends data to a router (e.g., another software component). Examples of data that a detector sends may include purchase orders received by providers of synthetic DNA.

Routers 404 also referred to as message brokers in one embodiment may be software components used to intercept messages passed between components and then route messages to subscribers. Routers 404 are used in the system in one embodiment to spool data efficiently. Routers 404 help to scale outgoing message throughput as the number of upstream data producers or downstream consumers increase. Routers 404 are used in this architecture as brokers. In one embodiment, the way a router is used to route messages between two components (A and B) is for component A to publish a URI address of a data package to the router under a topic queue. Component B then receives the URI from the router and uses that URI to locate and connect directly to the data stream. Routers 404 allow multiple components to send messages to a given set of subscribers, and for multiple consumers to receive messages in alternative protocols (e.g., round-robin instead of broadcast).

Sensors also referred to as analytical elements 406 in one embodiment are state machines in the system and perform analysis on the streaming data. As the data streams pass the sensor 406, the sensor 406 monitors the data stream for a match in one or more catalogs (e.g., specified in the scenario document). One or more catalogs may be obtained from publicly available sources and/or from those not publicly available, but obtainable for instance through agreements. Using the botulinum toxin gene sequence as an example, a catalog may contain publically available sequences obtained from the National Center for Biotechnology. The catalog may also contain botulinum toxin gene sequences that are not in the public domain if those sequences are made available through an agreement. If it finds a match between the purchase order data stream and information from one or more catalogs, it changes state and publishes a state change message to its outgoing queue along with the context. The sensor context describes the conditions that cause the sensor to change state. The sensor 406 may also publish the detector context associated with the detector from which the data that contributed to the state change originated.

In one embodiment of the present disclosure, controllers execute the decision logic 408 that integrate results from one or more sensors. The decision logic 408 may have been specified in the scenario document. Controllers 408 embody the decision logic needed to process state change output from one or more sensors. As an example, the decision logic may have been described in the scenario in human readable text as a set of statements such as “if sensor one detects restriction enzyme sites and sensor two detects Ebola Virus sequences and the restriction sites flank the Ebola Virus sequences” then issue an advisory and include information from the scenario describing the reconstruction of the Ebola Virus genome from restriction fragments×. Such logic may be represented in programming logic in the controller. When the decision logic supports the issuance of an advisory, a message is published that contains details of the logic along with the context, e.g., which scenario document and which purchase order the advisory is associated with. The controller context describes the conditions that caused the controller to publish the message. A controller 408 may also publish the sensor context for each sensor that it is receiving state changes from and the detector context for the detector from which each sensor received data.

Advisories 410 also referred to as alerts indicate to the users that a scenario is taking place. An advisory 410 contains supporting information. The supporting information may be derived from the scenario, detector context, sensor context and controller context.

Context objects may contain meta-data that is provided with the initial data or generated during the processing of the data. The context objects are encapsulated in messages routed through the system kernel. The lifecycle of a context object persists over the course of an analysis and is generally limited to a batch of messages as determined by the detector. Each processing component of the system may produce one or more context objects. An analysis may begin with context object creation when a router receives a message from a detector indicating that new data is available. Multiple context objects (e.g., a detector context and a sensor context) are generally collapsed into a single context object for performance efficiency, but need not be collapsed.

Biotech companies selling DNA synthesis services may utilize the methodology disclosed here to screen purchase orders.

The system and methodology of the present disclosure in one embodiment may perform comparison or analysis of a DNA sequence on a genetic element basis. For instance, by analyzing and/or comparing genetic elements of parts of a whole genome, the system and methodology of the present disclosure is able to detect pieces of gene constructs in a purchase order, which if put together with other pieces in another purchase order could be made or constructed into a harmful threatening agent. For instance, a first gene sequence order received at company A and a second gene sequence order received at company B, when tested individually or independently may not be determined to be threatening. However, a piece of the gene sequence in the first gene sequence order when put together with another piece of the gene sequence in the second gene sequence order may be harmful or threatening. A possible threat posed by the two separate orders may go undetected if the two orders are tested separately. The methodology of the present disclosure in one embodiment is enabled to detect threats in such orders and provide alerts, for instance, by analyzing the elements of the ordered gene sequence.

An ordered gene sequence when compared as a whole or in its entirety may not be noted to be threatening; but it may still contain pieces or elements which could be constructed into a threatening agent. The methodology of the present disclosure may be enabled to detect such pieces.

Various aspects of the present disclosure may be embodied as a program, software, or computer instructions stored in a computer or machine usable or readable storage medium, which causes the computer or machine to perform the steps of the method when executed on the computer, processor, and/or machine. A computer readable storage medium or device may include any tangible device that can store a computer code or instruction that can be read and executed by a computer or a machine. Examples of computer readable storage medium or device may include, but are not limited to, hard disk, diskette, memory devices such as random access memory (RAM), read-only memory (ROM), optical storage device, and other recording or storage media.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

As used in the present disclosure, the singular forms “a”, “an” and “the” are intended to include the plural forms as well, unless the context clearly indicates otherwise.

The components of the flowcharts and block diagrams illustrated in the figures show various embodiments of the present invention. It is noted that the functions and components need not occur in the exact order shown in the figures. Rather, unless indicated otherwise, they may occur in different order, substantially simultaneously or simultaneously. Further, one or more components or steps shown in the figures may be implemented by special purpose hardware, software or computer system or combinations thereof.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of screening for providers of synthetic double stranded DNA, comprising:
examining gene sequences for a genetic construct;
generating, by a processor, an event containing system context at a point when the event was generated in response to determining that the genetic construct is found;
merging the system context with information from a scenario that describes the genetic construct;
generating an advisory containing the merged information; and
publishing the advisory.

2. The method of claim 1, further including receiving the scenario that describes the genetic construct.

3. The method of claim 1, wherein the merged information further includes information associated with a purchaser of the gene sequences.

4. The method of claim 1, wherein the genetic construct is a part of a whole genome.

5. The method claim 1, wherein the examining gene sequences for a genetic construct includes examining parts of gene sequences for a genetic construct to find a match.

6. A computer readable storage medium storing a program of instructions executable by a machine to perform a method of screening for providers of synthetic double stranded DNA, comprising:
examining gene sequences for a genetic construct;
generating an event containing system context in response to determining that the genetic construct is found;
merging the system context with information from a scenario that describes the genetic construct;
generating an advisory containing the merged information; and
publishing the advisory.

7. The computer readable storage medium of claim 6, further including receiving the scenario that describes the genetic construct.

8. The computer readable storage medium of claim 6, wherein the merged information further includes information associated with a purchaser of the gene sequences.

9. The computer readable storage medium of claim 6, wherein the examining gene sequences for a genetic construct includes examining parts of gene sequences for a genetic construct to find a match.

10. A system for screening for providers of synthetic double stranded DNA, comprising:
a plurality of detectors operable to produce data stream associated with a gene sequence being purchased by an entity;
a plurality of sensors operable to identify in the data stream matching genetic construct from a pre-identify catalog, the plurality of sensors further operable to generate an event in response to finding a match; and
a plurality of controllers operable to publish a message based on the generated event, the message including information associated with the data stream having the matching genetic construct.

11. The system of claim 10, wherein the information includes:
controller context that describes one or more conditions that caused the controller to publish the message.

12. The system of claim 10, wherein the information further includes:
sensor context for each sensor that is generating the event.

13. The system of claim 12, wherein the information further includes:
detector context associated with the detector from which said each sensor received the data stream matching genetic construct.

14. The system of claim 10, further including:
a plurality of advisories indicating to one or more users that a scenario is taking place.

15. The system of claim 10, wherein the genetic construct is a part of a whole genome.
